(19) United States
(12) Patent Application Publication
(10) Pub. No.: US 2023/0415975 A1
(43) Pub. Date: Dec. 28, 2023

(54) CAPSULE, FOOD OR BEVERAGE PREPARATION MACHINE FOR PROCESSING A CAPSULE, AND FOOD OR BEVERAGE PREPARATION PROCESS IMPLEMENTING SUCH A FOOD OR BEVERAGE PREPARATION MACHINE AND CAPSULE

(71) Applicant: SOCIETE DES PRODUITS NESTLE S.A., Vevey (CH)

(72) Inventors: CHRISTOPHE SEBASTIEN PAUL HEYDEL, Linwood, NJ (US); DAVID NORDQVIST, Echichens (CH)

(21) Appl. No.: 18/249,327

(22) PCT Filed: Oct. 1, 2021
(86) PCT No.: PCT/EP2021/077150

§ 371 Date: Apr. 17, 2023

(30) Foreign Application Priority Data
Oct. 21, 2020 (EP) 20203103.5

(51) Int. Cl. B65D 85/804; A47J 31/40; A47J 31/46

(52) U.S. Cl. CPC B65D 85/8046; A47J 31/407; A47J 31/46

(57) ABSTRACT

The invention is directed to a capsule comprising a container (1) enclosing a dose (2). The container (1) is composed of a dissolvable material and has an openable part for cooperating with the preparation machine so as to open the container (1) sufficiently for the dose (2) to be separable from the container (1). The invention is also directed to a preparation machine for processing a capsule. The preparation machine comprises an opening unit (125) having ii) an opening configuration where it cooperates with an openable part of the capsule to open the container (1) sufficiently for the dose (2) to be separable from the container (1). The invention is further directed to a food or beverage preparation process implementing such a capsule and preparation machine.

### 1. FIELD OF THE INVENTION

The invention is directed to a container enclosing a dose of a food or beverage ingredient. The invention is further directed to an assembly including such a container and a food or beverage preparation machine, for preparing a food or beverage product.

### 2. TECHNICAL BACKGROUND

Such containers are configured to enclose a dose of a food or beverage ingredient, e.g. coffee ground or tea extract, so as to prepare a food or beverage, e.g. coffee or tea, when placed in a food or beverage preparation machine. During a preparation process, the food or beverage preparation machine is configured to inject a drinkable liquid like water in the container. After interaction of the food or beverage ingredient with the injected liquid, the beverage is discharged out of the container and dispensed in a cup or a glass, from which the user may ingest the beverage or food. Then, the container is discarded along with the used food or beverage ingredient contained therein. Such containers are commonly made of plastics or plastic laminates.

However, the materials composing these containers are difficult or long to recycle or compost. As a result, a certain amount of waste can be produced and it requires quite some energy to handle this waste.

### 3. SUMMARY OF THE INVENTION

It is thus an object of the invention to provide a container enclosing a dose of a food or beverage ingredient, which can alleviate or obviate the shortcomings of the existing containers. Another object of the invention is to provide an assembly including such a container and a food or beverage preparation machine. In the following are described various aspects and embodiments of the invention.

According to a first aspect, the invention is directed to a capsule comprising a dose of a food or beverage ingredient and a container enclosing the dose, the capsule being suitable for preparing a food or beverage product in a food or beverage preparation machine,
wherein the container is composed of at least one dissolvable material, the container optionally consisting essentially in said at least one dissolvable material, the container preferably consisting only in said at least one dissolvable material,
wherein the container has an openable part configured to cooperate with the food or beverage preparation machine so as to open the container sufficiently for the dose to be separable from the container.

Thus, the container can be easily and quickly composted or dissolved, while requiring little or no energy from the user to handle the produced waste. It suffices that the used container gets wet, for example when stored together with the used food or beverage ingredient. The composting or dissolution of the container can be all the more so quick as the container may be relatively thin. Indeed, the container does not need to withhold an injection of liquid, especially of hot liquid, since the dose is separated from the container before being processed in the food or beverage preparation machine.

Further, the container may enhance the user experience, since the user does not need to open or empty any envelope or packaging before having the food or beverage product prepared. Also, the usual plastic waste due to such an envelope or packaging is not generated by a container according to the present invention.

In the present disclosure, the term “food or beverage ingredient” may be construed as encompassing also ingredients suitable for preparing a food product and a beverage product concomitantly.

In the present disclosure, the term “dissolvable” may be construed as qualifying a material that has a relatively high solubility in the liquid, say in water, in particular under the following conditions: A membrane made out of a dissolvable material and having 100 μm (microns) of thickness dissolves in water in less than 10 minutes at ambient temperature and under atmospheric pressure.

In the present disclosure, the term “consisting essentially in” may be construed as meaning that that specific further components can be present, namely those not materially affecting the essential characteristics of the container. For example, a container consisting essentially in the at least one dissolvable material may comprise between 90 and 99% of said dissolvable material.

In the present disclosure, the term “consisting only in” or “consisting in” may be construed as meaning that no further materials are present in the container other than the at least one dissolvable material.

According to an embodiment, the at least one dissolvable material may consist essentially in at least one edible material, the container preferably consisting only in said at least one edible material, the at least one dissolvable material being more preferably selected in the group consisting of: seaweed, seaweed extract, celluloses, polysaccharides, proteins, and mixtures thereof, the seaweed including in particular alginates, polysaccharides including in particular pullulan.

Thus, the container may be eaten by a user, in particular after the preparation of the food or beverage product. Such edible materials may preserve the food or beverage ingredient, and the container may be relatively easy to manufacture, manipulate and transport.

Each one of these edible materials has been subject to a complete assessment under a number of criteria, including functional, mechanical and safety criteria as well as the suitability of the edible material for liquids. In particular, these edible materials may provide relatively high oxygen barrier properties and/or moisture barrier properties.

Besides, some, most or all of these edible materials may be tasteless and odourless and offer a good processability to shape the container, in particular an ability to be printed on and heat-sealed.

In particular embodiments:
pullulans are for example available under the tradenames Listerine Pocketpaks® and Capsugel Plantcaps®;
the seaweed or seaweed extract may be selected in the group consisting of: alginates, agars, algae, carrageenan, and mixtures thereof;
seaweeds are for example available under the tradenames Evoware and Loliware;
the cellulose may be selected in the group consisting of: methylcellulose (MC), carboxymethylcellulose (CMC), hydroxypropylcellulose (HPC), hydroxyethylcellulose (HEC), hydroxypropylmethylcellulose (HPMC), and mixtures thereof;
a CMC and a HPMC are for example available respectively under the tradenames NatureFlex™ and Capsugel Licaps®;
the polysaccharides may be selected in the group consisting of: corn starch, potato starch, tapioca starch, maize starch, and mixtures thereof;
the proteins may be selected in the group consisting of: soy protein isolate, corn zein, whey, caseins, caseinates, and mixtures thereof;
the alginates may be selected among salts of alginic acid;
alginates are for example available under the tradenames Ooho!® commercialized by the company Skipping Rocks Lab, and WikiCell.

In some embodiments, the at least one dissolvable material may have oxygen barrier properties. Thus, the food or beverage ingredient may be relatively well preserved from oxidation before use, hence have a relatively long shelf life.

In the present disclosure, the term “oxygen barrier properties” may be construed as meaning that less than 3 cm³/m²/day/bar (cubic centimeter per square meter per day per bar) of oxygen may pass through a membrane consisting in the dissolvable material at 23° C. (Celsius) and 50% (percent) of relative humidity (RH).

In some embodiments, the at least one dissolvable material may be dissolvable in a liquid, say water at a temperature comprised between 50° C. and 100° C. under atmospheric pressure.

In some embodiments, the thickness of the container may be substantially constant. Alternatively, the thickness of the container may vary.

According to an embodiment, the food or beverage ingredient may be selected in the group consisting of: ground coffee, coffee extract, tea leaves, tea extract, sugar, milk powder, vegetable powder, fruit powder, and mixtures thereof.

Thus, the containers may be provided with various food or beverage ingredients in order to prepare various food or beverage products.

According to an embodiment, the food or beverage ingredient may be in a compact state, the dose forming preferably a single lump.

Thus, the dose may easily be separated from the container, in order to be processed in the food or beverage preparation machine.

In some embodiments, the dose may form more than one lump. Alternatively, the dose may be in a powdery form.

In some embodiments, the container may be coated with a film made of a material having high moisture barrier properties, the film being preferably secured to the container by lamination before shaping the container, the film being preferably selected in the group consisting of: gums, waxes, celluloses, and mixtures thereof.

Thus, the high moisture barrier properties may enhance the preservation of the container and the food or beverage ingredient therein. Such film may be selected as at least partially dissolvable.

In the present disclosure, the expression “high moisture barrier properties” may be construed as designating a material that lets pass, through a membrane, less than 3 g/m²/day (grams per square meter per day) of humidity at 23° C. (Celsius) and 85% of relative humidity (RH) under atmospheric pressure.

Preferably, such film may be secured to the container by lamination before shaping the container. Preferably, such a film may be selected in the group consisting of: gums, waxes, celluloses, and mixtures thereof. Optionally, the gum may be selected in the group consisting of: xanthan gum, gellan gum, seed gum, and mixtures thereof. More preferably, the wax may be selected in the group consisting of: bees wax, carnauba, paraffin, and mixtures thereof. More preferably, the cellulose may be selected in the group consisting of: methylcellulose (MC), carboxymethylcellulose (CMC), hydroxypropylcellulose (HPC), hydroxyethylcellulose (HEC), hydroxypropylmethylcellulose (HPMC).

In some embodiments, the container may include, in the formulation of the at least one dissolvable material, at least one additive selected to increase the moisture barrier properties of the dissolvable material. Preferably, such an additive may be a plasticizer, which may optionally be selected in the group consisting in: glycerol, alginates, and mixtures thereof.

In some embodiments, the container may be composed of a blend of dissolvable materials, for example: a blend of sodium alginate and pullulan film, a blend of calcium caseinate and citrus pectin, or a blend of various starches. Thus, the moisture barrier properties may be enhanced.

In some embodiments, the container further comprises at least one paper layer including paper or paper fibers, said at least one paper layer preferably consisting in paper or paper fibers, said at least one paper layer surrounding the at least one dissolvable material.

Thus, such paper layer(s) may enhance the preservation, hence increase the shelf life, of the food or beverage ingredient, while enhancing its ability to be manipulated, stored, transported and used. The paper layer may form a secondary packaging, while the dissolvable material may form a primary packaging that is directly in contact with the food or beverage ingredient.

According to an embodiment, the container may comprise at least one part defining a cavity for receiving the dose and at least one part configured to close said cavity, said parts having respective flanges sealed together, preferably in a liquid-tight manner, such that the container may be configured as a closed package, the flanges being optionally flexible, the flanges optionally having an annular protruding shape extending partially or totally around the cavity.

Thus, the container may easily be inserted in the food and beverage preparation machine. Since the flanges may accommodate slightly inaccurate positions, hence small stresses, during the manipulation, storage, transportation, and installation of the container in the food or beverage preparation machine, it may be avoided that the rest of the container be subject to such stresses. Further, the flanges may prevent an ingress of moisture or other external element in the container.

In some embodiments, the dose may have a first region configured to cooperate with an injection device that is part of a food or beverage preparation machine and that has in particular a plurality of injectors distributed over an injection area, the injection device being for example in the form of a shower. Further, the dose may have a second region configured to cooperate with a discharging device that is part of the food or beverage preparation machine and that has a plurality of discharging channels distributed over a discharging area.

Thus, as the first and second regions may have relatively large surface areas with respect to the overall surface area of the dose in order to respectively cooperate with a large injection device and a large discharging device, the liquid may quickly cover and impregnate most or all of the dose. This can enhance the taste of the food or beverage product, while decreasing the preparation time.

In some embodiments, the first region may have a substantially flat surface, preferably a flat surface, and/or wherein the second region may have a substantially flat surface, preferably a flat surface,
the first region optionally having substantially or exactly the shape of a circular disc, and/or the second region optionally having substantially or exactly the shape of a circular disc.

Thus, such design of the first region and/or of the second region may simplify the design and manufacturing of the injection device and/or of the puncturing device.

In some embodiments, the container may have a relatively flat shape, thus providing relatively large surface areas for the first region and/or the second region.

According to a second aspect, the invention is directed to a food or beverage preparation machine, configured to receive and process a capsule so as to prepare a food or beverage product, and comprising i) a dose of a food or beverage ingredient and ii) a container enclosing the dose and composed of, or consisting essentially or only in, at least one dissolvable material,
wherein the food or beverage preparation machine comprises an opening unit configured to be placed in an opening configuration in which the opening unit cooperates with an openable part of the container so as to open the container sufficiently for the dose to be separable from the container, the opening unit being preferably configured to move between i) a rest configuration and ii) the opening configuration.

Thus, such a food or beverage preparation machine may open the container and process the dose after it has been separated from the container, while the container can be easily and quickly composted or dissolved.

The food or beverage preparation machine may cooperate with any capsule according to the afore-detailed embodiments.

In some embodiments, the beverage preparation machine may include an electronic control unit, which is configured to control various components and units of the food or beverage preparation machine, in particular to carry out the food or beverage preparation process. The food or beverage preparation machine may further comprise a memory including a software or program configured to carry out the food or beverage preparation process.

In some embodiments, the opening unit may include an opening actuator, which is configured to position the opening unit in accordance with instructions received from the electronic control unit. Moving the opening unit from the position where it opens the container may save space for moving other units of the food or beverage preparation machine.

According to an embodiment, the opening unit may comprise a cutting element configured to cut open the openable part with an opening sufficiently wide for the dose to be separable from the container through said opening, said openable part extending preferably along a cooperating angle of more than 180 degrees, more preferably of more than 235 degrees, the cutting element preferably including a toothed blade.

Thus, the cutting element may quickly open the container, while the wide cooperating angle facilitates the separation of the dose from the container.

According to an alternative embodiment, the openable part may have a precut line arranged to provide an opening sufficiently wide for the dose to be separable from the container.

According to an embodiment, the opening unit may be further configured to leave intact a joining portion of the container when opening the openable part, such that the joining portion may join both sides defining the opening.

Thus, the cutting element may allow the container, in particular its joining portion, to remain attached to the food or beverage preparation machine while the dose gets separated from the container.

According to an embodiment, the food or beverage preparation machine may further comprise a separating unit configured to move between i) a rest configuration and ii) a separating configuration in which the separating unit pushes against the capsule so as to separate the dose from the container, the separating unit preferably including a piston.

Thus, the separating unit may quickly separate the dose from the container. Further, the piston may form a compact separating unit.

In some embodiments, the separating unit may include a separating actuator, which is configured to position the separating unit in accordance with instructions received from an electronic control unit.

According to an embodiment, the food or beverage preparation machine may further comprise a holding unit configured to move between: i) a rest configuration and ii) a holding configuration in which the holding unit holds the container in place while the opening unit cooperates with the openable part, preferably while the separating unit pushes against the capsule.

Thus, the holding unit may retain the container while the dose is separated from it.

In some embodiments, the holding unit may include a holding actuator, which is configured to position the holding unit in accordance with instructions received from the electronic control unit.

According to an embodiment, at least one of the separating unit and the holding unit may be configured to move parallel to, preferably coaxially to, the opening unit, preferably along a linear direction, more preferably along a vertical direction.

Thus, the arrangement of the separating unit and holding unit may save space, hence help designing a compact food or beverage preparation machine.

According to an embodiment, the food or beverage preparation machine may further comprise:
an injection device configured to inject a liquid in the dose, and
a transferring unit configured to move between: i) a receiving configuration, in which the transferring unit may receive the dose, and ii) a preparation configuration, in which the transferring unit places the dose in fluidic connection with the injection device, the transferring unit being preferably configured to discharge the beverage product out of the capsule.

Thus, the transferring unit may facilitate the transfer of the dose to the injection device, while the container is discarded.

In some embodiments, the transferring unit may include a transferring actuator, which is configured to position the transferring unit in accordance with instructions received from the electronic control unit.

In some embodiments, at least one of, preferably all of, the opening actuator, the separating actuator, the holding actuator, and the transferring actuator may be a linear actuator, i.e. actuators that creates motion in a straight line. Preferably, at least one of, preferably all of, the opening actuator, the separating actuator, the holding actuator, and the transferring actuator may comprise an electric motor.

According to an embodiment, the transferring unit may be further configured to move between: ii) the preparation configuration and ii) a discarding configuration in which the dose may be discarded out of the transferring unit.

Thus, the transferring unit may enhance the user's experience, since the transferring unit may automatically discard the dose.

According to an embodiment, the food or beverage preparation machine may further comprise a collecting chamber arranged to collect the container, the collecting chamber being preferably arranged to also collect the dose after the preparation of a food or beverage product.

Thus, the container may compost or dissolve in the collecting chamber. Further, the used dose may wet the container, hence accelerate the composting or dissolution thereof.

Alternatively, the food or beverage preparation machine may comprise an additional collecting chamber for collecting the discarded separately from the separated containers that can be collected in the collecting chamber.

According to a third aspect, the invention may be directed to an assembly including i) a food or beverage preparation machine according to any one of the afore-detailed aspect or embodiments and ii) a container to any one of the afore-detailed aspect or embodiments.

In some embodiments, the food or beverage preparation machine may comprise an injection device having a plurality of injection channels distributed over an injection area, for example in the form of a shower. Further, the food or beverage preparation machine may comprise a discharging device having a plurality of discharging channels distributed over a discharging area.

Thus, the design of the injection device may promote a uniform distribution in the flow of the liquid entering the dose, which optimizes the use of the food or beverage ingredient. Further, the design of the discharging device may promote a uniform distribution in the flow of the food or beverage product exiting from the container, hence facilitate the collection of the food or beverage product.

According to a fourth aspect, the invention is directed to a food or beverage preparation process for preparing a food or beverage product, the food or beverage preparation process comprising:
202) implementing a food or beverage preparation machine according to any of the afore-detailed aspect and embodiments and a capsule according to any of the afore-detailed aspect and embodiments,
204) placing the capsule in the food or beverage preparation machine,
206) opening the container sufficiently for the dose to be separable from the container,
208) separating the dose from the container, and preferably discarding the container in a collecting chamber,
210) placing the dose in a preparation configuration, preferably by means of a transferring unit,
214) injecting liquid in the dose, preferably by means of an injection device,
216) discharging the food or beverage product, preferably through the transferring unit, and
220) discarding the dose, preferably by putting the dose in the collecting chamber such that the dose may wet the container.

Thus, such a food or beverage preparation process may be operated easily, while enhancing the ease and speed of composting or recycling of the containers used therein, and requiring little or no energy to handle the produced waste.

### 4. BRIEF DESCRIPTION OF DRAWINGS

Further features, details and advantages of the invention will now be described in relation to the embodiments of the enclosed figures.

FIG. 1 shows a schematic perspective view of a capsule according to an embodiment of the invention.

FIG. 2 shows a schematic perspective exploded view of the capsule of FIG. 1.

FIG. 3 shows a schematic top view of the capsule of FIG. 1, after it has been cut open.

FIG. 4 shows a schematic perspective cut view of the assembly of FIG. 3.

FIG. 5 shows a schematic perspective view cut along a middle vertical plane of a beverage preparation machine according to an embodiment of the invention.

FIG. 6 shows a schematic perspective view of a part of an opening unit of the beverage preparation machine of FIG. 5.

FIG. 7 shows a flow diagram of a beverage preparation process according to an embodiment of the invention and implementing the capsule of FIG. 1 and the beverage preparation machine of FIG. 5.

FIG. 8 shows a view similar to FIG. 5, illustrating an initial step of the beverage preparation process of FIG. 7, when the capsule of FIG. 1 is approached to the beverage preparation machine of FIG. 5.

FIG. 9 shows a view similar to FIG. 8, illustrating a subsequent step of the beverage preparation process of FIG. 7, when the capsule of FIG. 1 is introduced in the beverage preparation machine of FIG. 8.

FIG. 10 shows a view similar to FIG. 9, illustrating a subsequent step of the beverage preparation process of FIG. 7, when the capsule of FIG. 1 is held by a holding unit of the beverage preparation machine of FIG. 8.

FIG. 11 shows a view similar to FIG. 10, illustrating a subsequent step of the beverage preparation process of FIG. 7, when the capsule of FIG. 1 is opened by an opening unit of the beverage preparation machine of FIG. 8.

FIG. 12 shows a view similar to FIG. 11, illustrating a subsequent step of the beverage preparation process of FIG. 7, when the dose of the capsule of FIG. 1 is separated from the container of the capsule of FIG. 1 by a separating unit of the beverage preparation machine of FIG. 8.

FIG. 13 shows a view similar to FIG. 12, illustrating a subsequent step of the beverage preparation process of FIG. 7, when the dose of FIG. 12 is transferred by a transferring unit of the beverage preparation machine of FIG. 8.

FIG. 14 shows a view similar to FIG. 13, illustrating a subsequent step of the beverage preparation process of FIG. 7, when an extraction cell of the beverage preparation machine of FIG. 8 encloses the dose of FIG. 12, and when the container is dropped in a collecting chamber.

FIG. 15 shows a view similar to FIG. 14, illustrating a subsequent step of the beverage preparation process of FIG. 7, when a beverage is prepared in the extraction cell of FIG. 14, and dispensed in a user's cup.

FIG. 16 shows a view similar to FIG. 15, illustrating a subsequent step of the beverage preparation process of FIG. 7, when the dose of FIG. 15 is transferred toward the collecting chamber of FIG. 15 and after the beverage has been dispensed in the user's cup of FIG. 15.

FIG. 17 shows a view similar to FIG. 16, illustrating a subsequent step of the beverage preparation process of FIG. 7, when the dose of FIG. 16 is dropped in a collecting chamber of FIG. 14.

### 5. DETAILED DESCRIPTION

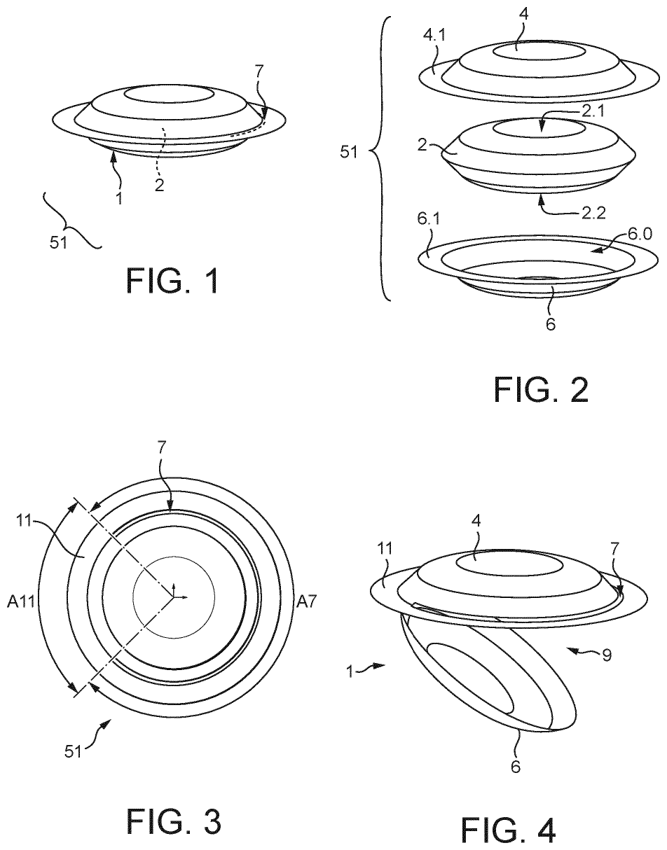

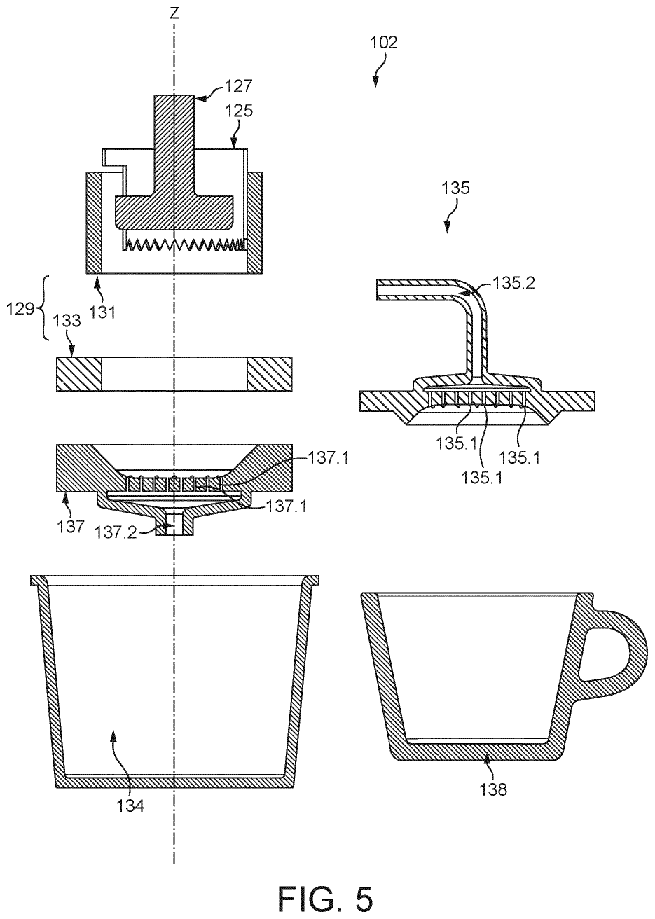

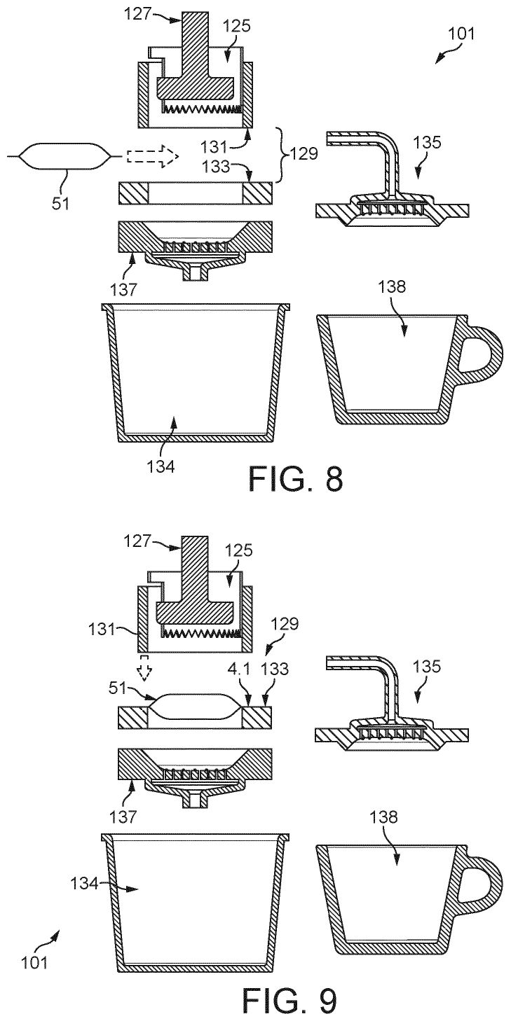

FIGS. 1, 2, 3 and 4 show, in accordance with the invention, a capsule 51 comprising a dose 2 of a beverage ingredient and a container 1 enclosing the dose 2. The capsule 51 is suitable to be introduced in a beverage preparation machine 102 of FIG. 5 as shown by the dashed arrow in FIG. 8. The beverage preparation machine 102 is configured to carry out a beverage preparation process 201 as illustrated in FIG. 7. The beverage preparation machine 102 is configured to receive the capsule 51, as visible in FIGS. 5 and 9. FIG. 8 shows an assembly 101 including the container 1 and the beverage preparation machine 102.

So, the beverage preparation process 201 (FIG. 7) comprises an initial step 202 of implementing the beverage preparation machine 102 and the capsule 51. The beverage preparation process 201 comprises a subsequent step 204 of placing the capsule 51 in the beverage preparation machine 102.

The beverage preparation machine 102 may include a non-illustrated electronic control unit, which is configured to control various components and units of the beverage preparation machine 102, in particular to carry out the beverage preparation process 201.

The container 1 of the capsule 51 may be composed of dissolvable material. For example, the container 1 may be composed of a blend of sodium alginate laminated with a pullulan film. The dissolvable material may have oxygen and/or moisture barrier properties. The dissolvable material may be dissolvable in hot water at a temperature, say at about 60° C. under atmospheric pressure.

The beverage ingredient may be ground coffee. The beverage ingredient may be in a compact state, the dose herein forming a single lump. The dose may generally have the shape of a disc or flat cylinder.

In the example of FIG. 1-4, the container 1 may form the sole packaging for the dose 2. This may enhance the user experience, since the user does not need to open or empty any envelope or additional packaging before having the beverage product prepared. Also, the usual plastic waste due to such an envelope or additional packaging is not generated with the container 1.

The container 1 may comprise a lower part 6 defining a cavity 6.0 for receiving the dose 2 and an upper part 6 closing the cavity 6.0. Each of the upper and lower parts 4, 6 may generally have the shape of a bulged disc or a saucer.

The upper and lower parts 4, 6 may have respective flanges 4.1, 6.1, which may be sealed together in a liquid-tight manner, such that the container 1 may be configured as a closed package and prevent an ingress of, e.g., moisture. The flanges 4.1, 6.1 as well as the upper and lower parts 4, 6 may be flexible. The flanges 4.1, 6.1 may have an annular protruding shape extending totally around the cavity 6.0 containing the dose 2. The flanges 4.1 and 6.1 may be flat.

The container 1 has an openable part 7 configured to cooperate with the beverage preparation machine 102, so as to open the container 1 sufficiently for the dose 2 to be separated from the container 1. The openable part 7 may be in the form of a partly annular region located at or near the junction of the flanges 4.1, 6.1 with the upper and lower parts 4, 6. The openable part 7 may extend on an angle A7 of about 270 degrees around a central portion of the capsule 51.

The beverage preparation machine 102 comprises an opening unit 125. The opening unit 125 is configured to be placed in an opening configuration (FIG. 11) in which the opening unit 125 cooperates with the openable part 7 of the container 1 (as shown by the dashed arrow in FIG. 11) so as to open the container 1 sufficiently for the dose 2 to be separable from the container 1.

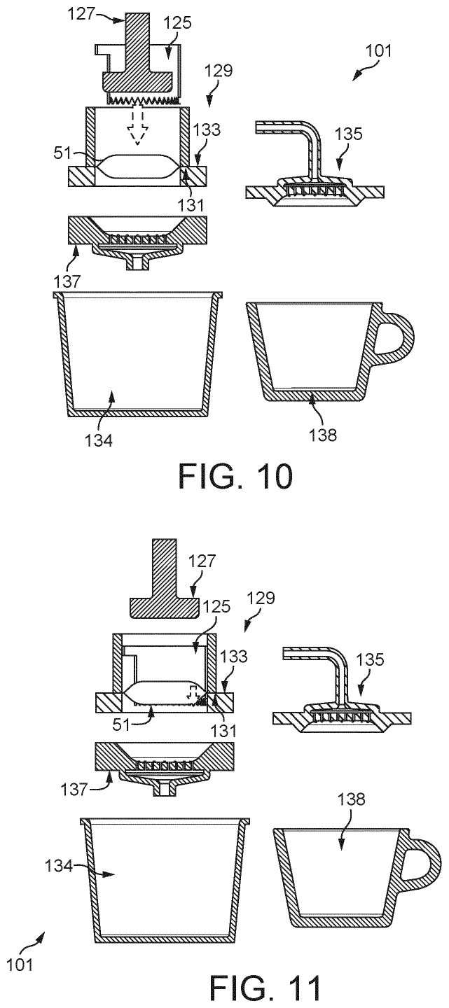

The opening unit 125 may herein be configured to move between i) a rest configuration (FIG. 10) and ii) the opening configuration (FIG. 11), as shown by the dashed arrow in FIG. 10. The opening unit 125 may include a non-illustrated opening actuator, which is configured to position the opening unit 125, in accordance with instructions received from the electronic control unit, herein along a vertical direction.

So, the beverage preparation process 201 (FIG. 7) comprises a subsequent step 206 of placing the opening unit 125 in the opening configuration, such that the opening unit 125 cooperates with the openable part 7 so as to open the container 1 sufficiently (angle A7) for the dose 2 to be separable from the container 1.

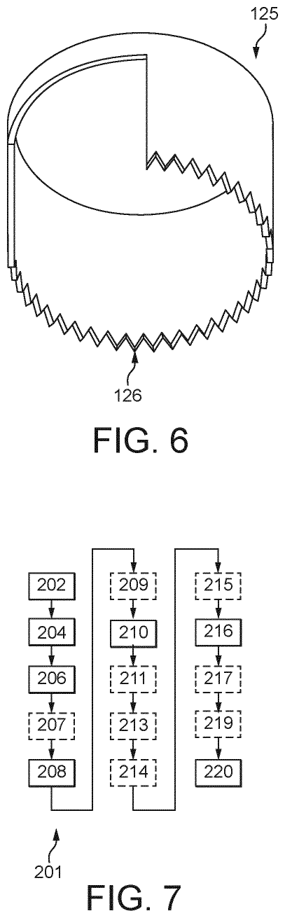

The opening unit 125 comprises a cutting element 126 as visible in FIGS. 5 and 6. The cutting element 126 may be configured to cut open the openable part 7 to form an opening 9 (FIG. 4) sufficiently wide for the dose 2 to be separable from the container 1 through the opening 9. After having been cut open the openable part 7 may form a slot, as visible in FIGS. 3 and 4.

As visible in FIG. 5, the cutting element 126 of the opening unit 125 may be comprised of a toothed blade. The opening unit 125 may generally have the shape of a portion of cylindrical tube extending on an angle of about 270 degrees.

The cutting element 126 may further be configured to, when cutting open the openable part 7, leave intact a joining portion 11 of the container 1 such that the joining portion may join both sides defining the opening. As visible in FIG. 4 after the cutting open of the openable part 7, the flange 6.1 of the lower part 6 remains 4.1, 6.1 tightly stuck to flange 4.1 of the upper part 4.

As illustrated in FIG. 3, the joining portion 11 may extend along a joining angle A11 of about 90 degrees around a central portion of the capsule 51, while the openable part 7 may complementarily extend on a cooperating angle A7 of about 270 degrees. Due to the joining portion 11 and the flanges 4.1, 6.1, the container 1 may remain attached to the beverage preparation machine 102 while the dose 2 gets separated from the container 1.

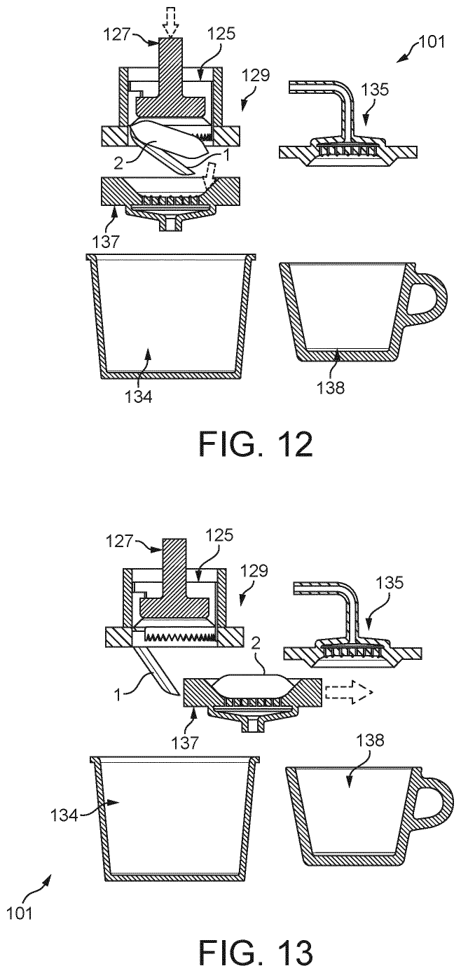

After the opening unit 125 has cut open the openable part 7, the dose 2 can be separated from the container 1, as illustrated in FIGS. 12 and 13, and get processed as hereinafter described, while the container 1 can be easily and quickly composted or dissolved.

The thickness of the dissolvable material may be selected such that the container 1 can hold the liquid injected therein. The thickness of the container 1 may be selected between 10 μm and 200 μm (microns). The thickness of the container 1 may be substantially constant. Further, the thickness of the container 1 and the composition of the dissolvable material may be selected, so as to achieve a composting over a certain length of time, for example of between a few hours and several weeks, e.g. up to 12 weeks.

The beverage preparation machine 102 may further comprise a separating unit 127, which is configured to move between i) a rest configuration (FIG. 11) and ii) a separating configuration (FIG. 12). In the separating configuration (FIG. 12), the separating unit 127 may push against the capsule so as to separate the dose 2 from the container 1, as shown by the dashed arrow in the top of FIG. 12.

The separating unit 127 may include a piston. The separating unit 127 may include a non-illustrated separating actuator, which is configured to position the separating unit 127, in accordance with instructions received from the electronic control unit, herein along a vertical direction.

So, the beverage preparation process 201 (FIG. 7) comprises a subsequent step 208 of having the separating unit 127 push against the capsule 51 so as to separate the dose 2 from the container 1.

The beverage preparation machine 102 may further comprise a holding unit 129, which is configured to move between i) a rest configuration (FIG. 9) and ii) a holding configuration (FIG. 10). The holding unit 129 may include a non-illustrated holding actuator, which is configured to position the holding unit 129, in accordance with instructions received from the electronic control unit, herein along a vertical direction.

In the holding configuration (FIG. 10) the holding unit 129 may hold the capsule 51 in place while the opening unit 125 cooperates with the openable part 7, herein while the separating unit 127 pushes against the capsule 51.

So, before or concomitantly to the separating step 208, the beverage preparation process 201 may comprise a sub-step 207 of having the holding unit 129 hold the capsule 51 in place. Thus, the separating unit 127 may push against the capsule 51.

The holding unit 129 may comprise a first holding member 131 and a second holding member 133, which are movable the one with respect to the other, as shown by the dashed arrow in FIG. 9. The first holding member 131 and the second holding member 133 may define respective cavities to accommodate the upper and lower parts 4, 6 respectively. In the example of FIG. 8-17 the first holding member 131 may generally have the shape of a cylindrical tube, and the second holding member 133 may generally have an annular or crown shape.

In the rest configuration (FIG. 9) the first holding member 131 and the second holding member 133 are distant from one another, such that a capsule 51 may be arranged between the first holding member 131 and the second holding member 133.

In the holding configuration (FIG. 10) the first holding member 131 and the second holding member 133 may be pressed or clamped against one another. As the capsule 51 is arranged between them, in particular the flanges 4.1, 6.1, the capsule 51 can be firmly held in place. The flange 4.1 of the upper part 4 may be compressed by the first holding member 131, while the flange 6.1 of the lower part 6 may be compressed by the second holding member 133.

As visible in FIG. 8 the separating unit 127 and the holding unit 129, e.g. the first holding member 131, may be configured to move coaxially to the opening unit 125 and to an axis Z as illustrated in FIG. 5. This coaxial arrangement may save space, hence make for a compact beverage preparation machine 102.

Further, the beverage preparation machine 102 may comprise a collecting chamber 134 arranged to collect the container 1 after it has been separated from the dose 2 by the separating unit 127. The collecting chamber 134 may be arranged to also collect the used dose 2. Thus, the container 1 may compost or dissolve in the collecting chamber 134. The used dose 2 may wet the container 1, hence accelerate the composting or dissolution thereof.

The collecting chamber 134 may be formed by a receptacle of a volume suitable for receiving several used containers 1 and, as the case may be, several used doses 2. The collecting chamber 134 may be detachably coupled to the beverage preparation machine 102. A user may detach the collecting chamber 134 to empty it from the used containers 1 and doses 2, and then recouple the collecting chamber 134 to the beverage preparation machine 102.

So, the beverage preparation process 201 (FIG. 7) comprises a sub-step 209 of discarding the container 1, for example by putting it in the collecting chamber 134.

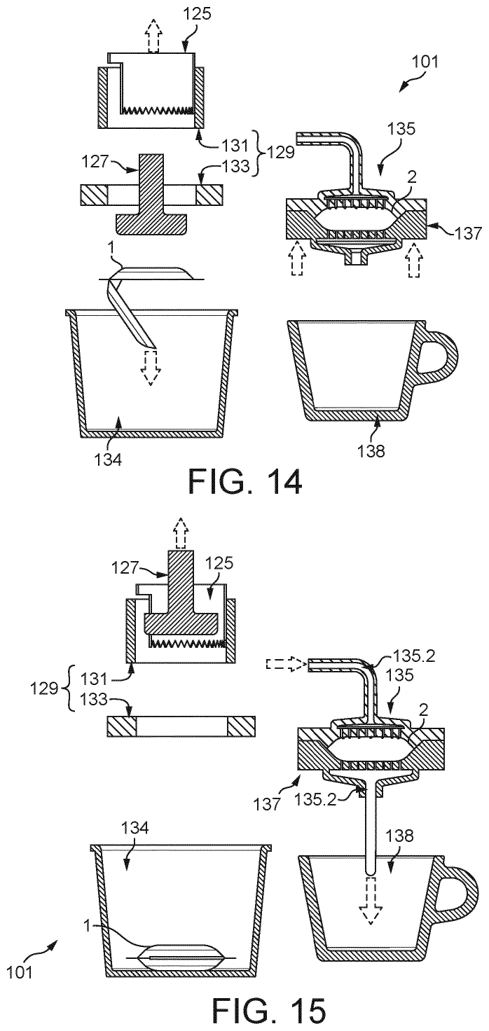

Further, the beverage preparation machine 102 may comprise an injection device 135, which is configured to inject a liquid in the dose 2. Also, the beverage preparation machine 102 may comprise a transferring unit 137, which is configured to move between i) a receiving configuration (FIG. 13) and ii) a preparation configuration (FIG. 14-15):
In the receiving configuration (FIG. 13) the transferring unit 137 may partly or totally accommodate the dose 2 after its separation from the container 1, as shown by the dashed arrow in the middle of FIG. 12. Then, the transferring unit 137 may transfer the dose 2 to the injection device 135, while the container 1 is discarded, as shown by the dashed arrow in the bottom of FIG. 14.
In the preparation configuration (FIG. 14-15), the transferring unit 137 may move the dose 2, as shown by the dashed arrow in FIG. 13, and place the dose 2 in fluidic connection with the injection device 135, for example under the injection device 135.

The transferring unit 137 may include a non-illustrated transferring actuator, which is configured to position the transferring unit 137, in accordance with instructions received from the electronic control unit, herein mostly in a horizontal plane.

So, the beverage preparation process 201 (FIG. 7) comprises a subsequent step 210 of fluidly connecting the dose 2 with the injection device 135. This connection step 210 may include a sub-step 211 of transferring the dose 2, via the transferring unit 137, to the injection device 135, herein from the receiving configuration (FIG. 13) to the preparation configuration (FIG. 14-15), as shown by the dashed arrow in the right part of FIG. 14.

The injection device 135 and the transferring unit 137 may together form an extraction cell of the beverage preparation machine 102, in which the dose 2 may be held during a beverage preparation step in the preparation configuration (FIG. 14-15). The injection device 135 and the transferring unit 137 respectively form an upstream component and a downstream component of this extraction cell.

The injection device 135 and the transferring unit 137 may be moveable with respect to one another between:
an open configuration as visible in FIG. 13, where a dose 2 may be introduced in or removed from the extraction cell, and
a closed configuration as visible in FIG. 14-15, where the dose 2 may be processed.

So, the beverage preparation process 201 (FIG. 7) may comprise a sub-step 213 of moving the injection device 135 and the transferring unit 137 in the closed configuration (FIG. 14-15), so as to close the extraction cell.

The injection device 135 may have a plurality of injectors 135.1 distributed over an injection area, for example in the form of a shower as in the example of FIG. 5, 8-17. The injection device 135 may further have an injection duct 135.2. The injection duct 135.2 may fluidly connect the injection device 135 to a non-illustrated liquid displacing unit, for example a pump, arranged upstream the injection duct 135.2.

As shown by the dashed arrow in FIG. 15, the injection device 135 may be configured to inject a liquid, for example water, flowing from the injection duct 135.2 into the dose 2 in order to have this liquid interact with the beverage ingredient.

So, the beverage preparation process 201 (FIG. 7) comprises a subsequent step 214 of injecting liquid in the extraction cell, preferably via the injection device 135. The beverage preparation process 201 (FIG. 7) may further comprise a sub-step 215 of stopping the injection of liquid.

The transferring unit 137 may be configured to discharge the beverage out of the dose 2, as shown by the dashed arrow in the bottom of FIG. 15. The transferring unit 137 may for example have a plurality of discharging channels 137.1, which may be distributed over a discharging area, and which may be in fluidic connection with the dose 2 in the preparation configuration (FIG. 14-15). The upstream ends of the discharging channels 137.1 may extend over a circle or disc.

The transferring unit 137 may further have a discharging duct 137.2 as visible in FIG. 15. The discharging duct 137.2 may fluidly connect the transferring unit 137, hence the dose 2, to a non-illustrated liquid dispensing unit, which may in turn dispense the beverage product into a receptacle 138 like a user's cup.

So, the beverage preparation process 201 (FIG. 7) comprises a subsequent step 216 of discharging the beverage product through the transferring unit 137, and preferably through the discharging duct 137.2 arranged in the downstream part of the transferring unit 137.

The dose 2 may have a first region 2.1 configured to cooperate with the injection device 135. As visible in FIG. 1-4 the first region 2.1 may have a flat surface in the shape of a circular disc. The first region 2.1 may have a relatively large surface area. Also, the dose 2 may have a second region 2.2 configured to cooperate with the transferring unit 137. The second region 2.2 may have a flat surface in the shape of a circular disc. Thus, the dose 2 and the container 1 may have relatively flat shapes. The second region 2.2 may have a relatively large surface area. Such relatively large surface areas may enhance respectively the ingress of the liquid in the dose 2 and the discharge of the beverage product out of the dose 2.

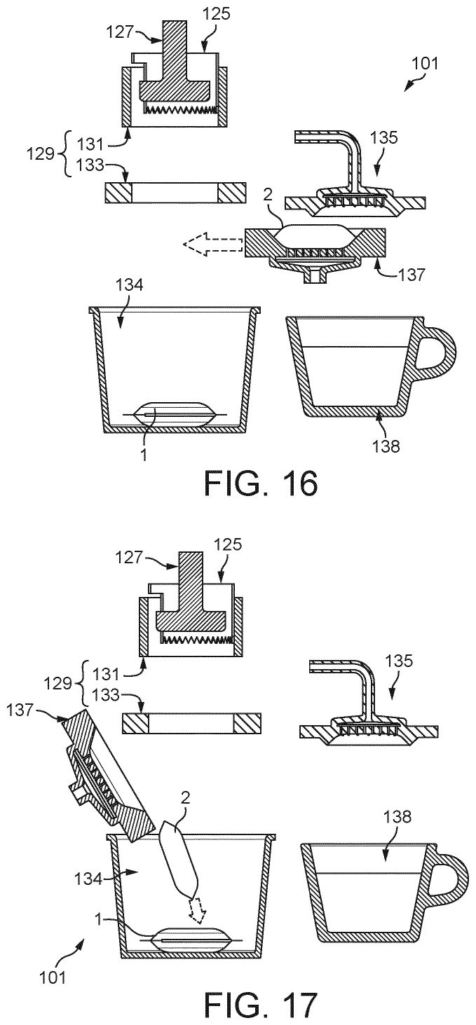

Further, the transferring unit 137 is configured to move between ii) the preparation configuration (FIG. 14-15) and ii) a discarding configuration (FIG. 17 via FIG. 16), as shown by the dashed arrow in FIG. 16. In the discarding configuration (FIG. 17), the dose 2 may be discarded out of the transferring unit 137, preferably in the collecting chamber 134 such that the dose 2 may wet the container 1, as shown by the dashed arrow in FIG. 17. The transferring unit 137 may pivot around a substantially horizontal axis so as to let the dose 2 slip or fall into the collecting chamber 134 under the action of gravity.

So, the beverage preparation process 201 (FIG. 7) may comprise a sub-step 217 of opening the extraction cell, a subsequent step 219 of removing the dose 2 from the transferring unit 137, and a step 220 of putting the dose 2 in the collecting chamber 134 such that the dose 2 may wet the container 1.

Thus, in the example of FIG. 7, the beverage preparation process 201 may comprise main steps (solid frames in FIG. 7) and optional sub-steps (dashed frames in FIG. 7):
202) implementing the beverage preparation machine 102 and the capsule 51,
204) placing the capsule 51 in the beverage preparation machine 102,
206) opening the container 1 sufficiently for the dose 2 to be separable from the container 1;
this step can be performed by placing the opening unit 125 in the opening configuration, such that the opening unit 125 cooperates with the openable part 7,
   207) having the holding unit 129 hold the capsule 51 in place,
208) separating the dose 2 from the container 1;
this step can be performed by having the separating unit 127 push against the capsule 51 so as to separate the dose 2 from the container 1,
   209) discarding the container 1, for example by putting it in the collecting chamber 134,
210) placing the dose 2 in the preparation configuration, preferably by means of the transferring unit 137,
   211) transferring the dose 2, via the transferring unit 137, to the injection device 135, herein from the receiving configuration (FIG. 13) to the preparation configuration (FIG. 14-15),
   213) moving the injection device 135 and the transferring unit 137 in the closed configuration (FIG. 14-15), so as to close the extraction cell and fluidly connect the dose 2 with the injection device 135,
214) injecting liquid in the dose 2, preferably by means of the injection device 135,
   215) stopping the injection of liquid,
216) discharging the beverage product, preferably through the transferring unit 137,
   217) opening the extraction cell,
   219) removing the dose 2 from the transferring unit 137, and
220) discarding the dose 2, preferably by putting it in the collecting chamber 134 such that the dose 2 may wet the container 1.

The invention is not limited to the afore-described embodiments, and other embodiments may be implemented as long as they are covered by the scope of protection conferred by one of the appended claims.

1. Capsule comprising a dose of a food or beverage ingredient and a container enclosing the dose, the capsule being suitable for preparing a food or beverage product in a food or beverage preparation machine,
the container is composed of at least one dissolvable material, and
the container has an openable part configured to cooperate with the food or beverage preparation machine so as to open the container sufficiently for the dose to be separable from the container.

2. Capsule according to claim 1, wherein the at least one dissolvable material consists essentially in in at least one edible material.

3. Capsule according to claim 1, wherein the food or beverage ingredient is selected from the group consisting of: ground coffee, coffee extract, tea leaves, tea extract, sugar, milk powder, vegetable powder, fruit powder, and mixtures thereof.

4. Capsule according to claim 1, wherein the food or beverage ingredient is in a compact state.

5. Capsule according to claim 1, wherein the container comprises at least one part defining a cavity for receiving the dose and at least one part configured to close said cavity, said parts having respective flanges sealed together.

6. Food or beverage preparation machine, configured to receive and process a capsule so as to prepare a food or beverage product, and comprising i) a dose of a food or beverage ingredient and ii) a container enclosing the dose and composed of at least one dissolvable material,
wherein the food or beverage preparation machine comprises an opening unit configured to be placed in an opening configuration in which the opening unit cooperates with an openable part of the container so as to open the container sufficiently for the dose to be separable from the container, the opening unit being preferably configured to move between i) a rest configuration and ii) the opening configuration.

7. Food or beverage preparation machine according to claim 6, wherein the opening unit comprises a cutting element configured to cut open the openable part with an opening sufficiently wide for the dose to be separable from the container through said opening, said openable part extending preferably along a cooperating angle of more than 180 degrees.

8. Food or beverage preparation machine according to claim 6, wherein the opening unit is further configured to leave intact a joining portion of the container when opening the openable part, such that the joining portion may join both sides defining the opening.

9. Food or beverage preparation machine according to claim 6, further comprising a separating unit configured to move between i) a rest configuration and ii) a separating configuration in which the separating unit pushes against the capsule so as to separate the dose from the container, the separating unit preferably including a piston.

10. Food or beverage preparation machine according to claim 6, further comprising a holding unit configured to move between: i) a rest configuration and ii) a holding configuration in which the holding unit holds the container in place while the opening unit cooperates with the openable part, preferably while the separating unit pushes against the capsule.

11. Food or beverage preparation machine according to claim 9, wherein at least one of the separating unit and the holding unit is configured to move parallel to, preferably coaxially to, the opening unit, preferably along a linear direction, more preferably along a vertical direction.

12. Food or beverage preparation machine according to claim 9 further comprising:
an injection device configured to inject a liquid in the dose, and
a transferring unit configured to move between: i) a receiving configuration, in which the transferring unit may receive the dose, and ii) a preparation configuration, in which the transferring unit places the dose in fluidic connection with the injection device, the transferring unit being preferably configured to discharge the beverage product out of the capsule.

13. Food or beverage preparation machine according to claim 12, wherein the transferring unit is further configured to move between: ii) the preparation configuration and ii) a discarding configuration in which the dose may be discarded out of the transferring unit.

14. Food or beverage preparation machine according to claim 13, further comprising a collecting chamber arranged to collect the container, the collecting chamber being preferably arranged to also collect the dose after the preparation of a food or beverage product.

15. (canceled)
